(19) United States
(12) Patent Application Publication
(10) Pub. No.: US 2017/0114227 A1
(43) Pub. Date: Apr. 27, 2017

(54) METHOD FOR MANUFACTURING FLUORINE-BASED RESIN COATING POWDER AND ELECTRODE MATERIAL

(71) Applicant: HYUNDAI MOTOR COMPANY, Seoul (KR)

(72) Inventor: Hae Won JEONG, Gwangmyeong-Si (KR)

(21) Appl. No.: 15/040,825

(22) Filed: Feb. 10, 2016

(30) Foreign Application Priority Data
Oct. 26, 2015 (KR) 10-2015-0148693

(51) Int. Cl. C09D 5/03; C10M 107/50; H01B 3/30; H01H 1/025; H01H 1/023; C09D 5/24; H01B 1/02

(52) U.S. Cl. CPC C09D 5/033; C09D 5/24; C10M 107/50; H01B 1/02; H01H 1/025; H01H 1/023; H01B 3/307; C10M 2229/003; H01H 2201/03

(57) ABSTRACT

A method for manufacturing a fluorine-based resin coating powder includes a silver powder preparing step of preparing a silver powder having a predetermined grain size, a silver powder solution mixing step of adding the silver powder to an ethanol solution, followed by mixing, a PH adjustment solution preparing step of preparing a solution having a pH that is adjusted to a set PH, a fluorine silane preparing step of preparing fluorine silane, and a fluorine-based resin coating silver powder manufacturing step of manufacturing a fluorine-based resin coating silver powder coated with the fluorine-based resin at a set thickness by adding the silver powder mixed with the ethanol solution in the silver powder solution mixing step and the fluorine silane prepared in the fluorine silane preparing step to the solution having the pH that is adjusted to the PH set in the PH adjustment solution preparing step, followed by mixing.

### CROSS-REFERENCE TO RELATED APPLICATION

This application claims the benefit of priority to Korean Patent Application No. 10-2015-0148693, filed with the Korean Intellectual Property Office on Oct. 26, 2015, the entire contents of which are incorporated herein by reference.

### TECHNICAL FIELD

The present disclosure relates to a method for manufacturing a fluorine-based resin coating powder and an electrode material, and more particularly, to a method for manufacturing a fluorine-based resin coating powder and an electrode material which is capable of improving durability and reliability of a switch contact point.

### BACKGROUND

Currently, about 100 or more switch contact points may be used in a vehicle. This is a phenomenon due to an increase in the number of electronic devices in the vehicle. These switches are essential parts of vehicle operation, and durability and reliability of the switches is directly connected to quality and reliability of the vehicle.

For example, if a consumer feels like opening a window of a driver's seat of the vehicle and thus operates a power window switch, but the window is not opened due to a failure in the switch, the consumer does not consider the event as a failure in the switch, but seems to consider that an entire vehicle window system is faulty.

Further, switches is used as important parts in controlling the vehicle. For example, a brake switch serves to transfer signals regarding whether a driver steps on a brake to various controllers, and to operate a brake lamp of a rear combination lamp of a rear part. Therefore, if the brake switch is out of order, a problem occurs in various control systems, and the brake lamp of the rear part is not turned on.

As described above, in accordance with an increase in importance of the switches in the vehicle, an importance of a contact point material that is essential to a lifespan and reliability of the switch has risen.

In a technology for improving workability by reducing an insertion force of a connector as an example of an existing technology, in order to reduce a surface friction coefficient, a coating film including a mixture of a fluorine-based resin particulate and fluorine-based oil can be formed on a surface of a contact point material base material of the connector.

Herein, a thickness of the coating film can be 0.2 to 0.5 μm, and a ratio of the fluorine-based resin particulate is 20 mass % to 40 mass % based on the total content of the fluorine-based resin particulate and fluorine-based oil in the coating film.

Like the connector, in the case where contact pressure is high and there is no movement once the connector is engaged, in engagement the friction coefficient is small, insertion force is low, and contact resistance is not largely increased.

However, in this technology, since a coating layer is thinly distributed on only the surface of the contact point material base material of the connector, coating peeling according to sliding durability occurs, and even though the coating thickness is 0.2 μm, this technology is disadvantageous in terms of contact resistance.

Further, in a case where grease is applied in order to reduce the friction coefficient of the switch contact point as another example of the existing technology, the following problems may exist. In general, when the switch is designed, it is assumed that the switch is operated on a flat surface. However, the switch/connector may be equipped in a slanted form. There is a problem in that if the grease is exposed at a high temperature over a long period of time, a viscosity of the grease is reduced, and the grease flows down toward a lower side of a slanted surface, and thus an intended function of the grease is lost.

The above information disclosed in this Background section is only for enhancement of understanding of the background of the disclosure and therefore it may contain information that does not form the prior art that is already known in this country to a person of ordinary skill in the art.

### SUMMARY OF THE DISCLOSURE

The present disclosure has been made in an effort to provide a method for manufacturing a fluorine-based resin coating powder and an electrode material, which may improve durability and reliability of a switch contact point and reduce a conductivity performance of a switch and a friction coefficient of the switch contact point itself to reduce abrasion.

An exemplary embodiment of the present disclosure provides a method for manufacturing a fluorine-based resin coating powder, the method may include: a silver powder preparing step of preparing a silver powder having a predetermined grain size,

a silver powder solution mixing step of adding the silver powder to an ethanol solution, followed by mixing,

a PH adjustment solution preparing step of preparing a solution having a pH that is adjusted to a set PH,

a fluorine silane preparing step of preparing fluorine silane, and

a fluorine-based resin coating silver powder manufacturing step of manufacturing a fluorine-based resin coating silver powder coated with the fluorine-based resin at a set thickness by adding the silver powder mixed with the ethanol solution in the silver powder solution mixing step and the fluorine silane prepared in the fluorine silane preparing step to the solution having the pH that is adjusted to the PH set in the PH adjustment solution preparing step, followed by mixing.

In the silver powder preparing step, the grain size may be 10 nm to 10 μm.

A coating thickness of the fluorine-based resin may be 1 nm to 10 nm.

In the PH adjustment solution preparing step, the pH of the solution may be set to a range of 2 to 7.5.

In the PH adjustment solution preparing step, the pH of the solution may be adjusted to the set pH by using an acid.

The acid may be formed of a nitric acid and an acetic acid not leaving a salt component in drying.

The fluorine silane may be formed of any one selected from perfluorooctyl triethoxysilane, triethyl(trifluoromethyl)silane, trimethyl(trifluoromethyl)silane, trimethoxy (3,3,3-trifluoropropyl)silane, trimethyl(trifluoromethyl)silane, dimethoxy-methyl (3,3,3-trifluoropropyl)silane, diisopropyl (3,3,4,4,5,5,6,6-nonafluorohexyl)silane, triethoxy[4-(trifluoromethyl)phenyl]silane, and 1H,1H,2H,2H-perfluorooctyltriethoxysilane.

Another exemplary embodiment of the present disclosure provides a method for manufacturing an electrode material, the method may include: a fluorine-based resin coating silver powder preparing step of preparing a fluorine-based resin coating silver powder where a silver powder having a predetermined grain size is coated with a fluorine-based resin at a set thickness,

a silver powder preparing step of preparing the silver powder having the predetermined grain size,

a silver powder mixing step of mixing the fluorine-based resin coating silver powder prepared in the fluorine-based resin coating silver powder preparing step and the silver powder prepared in the silver powder preparing step, and

a sintering step of printing a mixture powder mixed in the silver powder mixing step on a surface of an electrode and then sintering the mixture powder at a set sintering temperature.

In the silver powder preparing step, the grain size may be 10 nm to 10 μm.

A coating thickness of the fluorine-based resin may be 1 nm to 10 nm.

In the sintering step, the sintering temperature may be set to a range of 300 to 350° C.

In the sintering step, a sintering time may be set to a range of 1 to 30 minutes according to a printing amount.

According to the exemplary embodiments of the present disclosure, it is possible to simultaneously secure abrasion resistance and electric conductivity of an electric contact point.

As compared to general silver (Ag) plating, a friction coefficient is reduced and abrasion is reduced, and as compared to existing resin coating, electric conductivity is excellent (this is because resin coating is a non-conductive film and disturbs conductivity).

Further, fluorine silane of a surface of a fluorine-based resin coating silver powder trespasses on a sintered pore (pore effect) to attain a continuous lubrication effect, and thus even after performing repeated times, it is possible to attain the continuous lubrication effect.

In addition, even though a switch and a connector are equipped in a slanted form, a lubrication component does not flow down, and it is possible to reduce a silver plate thickness as compared to the same durable lifespan.

### BRIEF DESCRIPTION OF THE DRAWINGS

FIG. 1 is a schematic flowchart of a method for manufacturing a fluorine-based resin coating powder according to an exemplary embodiment of the present disclosure.

FIG. 2 is a schematic flowchart of a method for manufacturing an electrode material according to an exemplary embodiment of the present disclosure.

FIG. 3 is a view illustrating a use state of the electrode material manufactured according to the method for manufacturing the fluorine-based resin coating powder and the electrode material according to an exemplary embodiment of the present disclosure.

### DETAILED DESCRIPTION

The present disclosure will be described more fully hereinafter with reference to the accompanying drawings, in which exemplary embodiments of the disclosure are shown so as to be easily understood by the person with ordinary skill in the art. As easily understood by the person with ordinary skill in the art to which the present disclosure pertains, the exemplary embodiments which will be described below may be variously modified without departing from the spirit and the scope of the present disclosure. If possible, the same or similar portions are represented by using the same reference numeral in the drawings.

The terminologies used hereinafter are set forth just to illustrate a specific exemplary embodiment but not to limit the present disclosure. It must be noted that, as used in the specification and the appended claims, the singular forms include plural references unless the context clearly dictates otherwise. It will be further understood that the terms “comprises”, when used in this specification, specify the presence of stated properties, regions, integers, steps, operations, elements, and/or components, but do not preclude the presence or addition of one or more other properties, regions, integers, steps, operations, elements, components, and/or groups.

All terms including technical terms and scientific terms used herein have the same meaning as the meaning generally understood by the person with ordinary skill in the art to which the present disclosure pertains. The terminologies that are defined previously are further understood to have the meaning that coincides with relating technical documents and the contents that are disclosed currently, but not interpreted as the ideal or very official meaning unless it is defined.

A method for manufacturing a fluorine-based resin coating powder and an electrode material according to an exemplary embodiment of the present disclosure is a contact point material technology, or method, of reducing friction coefficients of a connector and a switch to reduce abrasion of a sliding-type contact point and thus improve electric durability and reliability, and allows metals sufficiently to come into contact with each other so that the friction coefficient is reduced but an electric conductive performance is not largely affected.

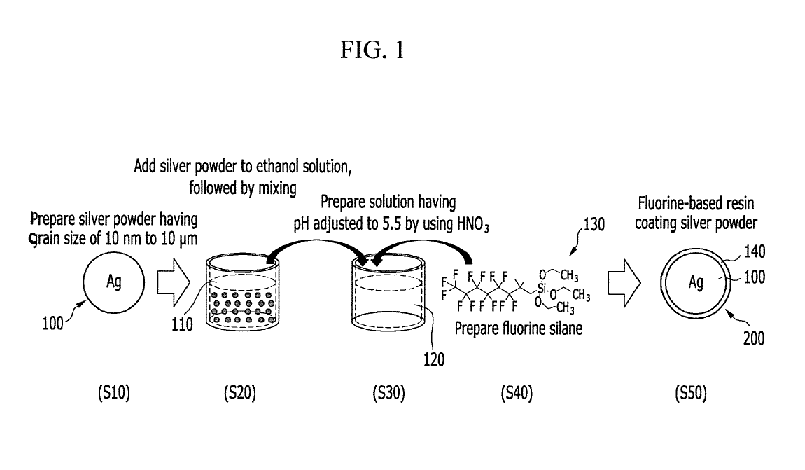

FIG. 1 is a schematic flowchart of the method for manufacturing the fluorine-based resin coating powder according to an exemplary embodiment of the present disclosure.

Referring to FIG. 1, the method for manufacturing the fluorine-based resin coating powder according to the exemplary embodiment of the present disclosure may include a silver powder preparing step (S10) of preparing a silver (Ag) powder 100 having a predetermined grain size, a silver powder solution mixing step (S20) of adding the silver powder 100 to an ethanol solution 110, followed by mixing, a PH adjustment solution preparing step (S30) of preparing a solution 120 having a pH that is adjusted to a set PH, a fluorine silane preparing step (S40) of preparing fluorine silane 130, and a fluorine-based resin coating silver powder manufacturing step (S50) of manufacturing a fluorine-based resin coating silver powder 200 coated with the fluorine-based resin 140 at a set thickness by adding the silver powder mixed with the ethanol solution 110 in the silver powder solution mixing step (S20) and fluorine silane 130 prepared in the fluorine silane preparing step (S40) to the solution 120 having the pH that is adjusted to the PH set in the PH adjustment solution preparing step (S30), followed by mixing.

In the silver powder preparing step S10, the grain size of the silver powder 100 may be 10 nm to 10 μm, and a set coating thickness of the fluorine-based resin 140 may be 1 nm to 10 nm.

In a case where the grain size of the silver powder 100 is 10 nm or less, the surface may not be coated well due to an agglomeration phenomenon of the silver powder 100, which is not suitable.

In addition, in a case where the grain size of the silver powder 100 is 10 μm or more, the size may be larger than about 1000 times of an actual coating thickness, and thus a friction reduction effect by coating may not be large, which is not suitable.

Further, in a case where the grain size of the silver powder 100 is 10 μm or more, a temperature at which the contact point is sintered may be largely increased to 600° C. or more, so that there may be concern about damage to a coating film, which is not suitable.

Therefore, it may be suitable that the grain size of the silver powder 100 is 20 nm to 10 μm, and it may be suitable that the coating thickness of the fluorine-based resin 140 is 1 nm to 10 nm.

In the PH adjustment solution preparing step S30, the pH of the solution 120 may be set to the range of 2 to 7.5 (the optimum range is 4 to 6). The reason why the range of the pH is set as described above is that when the pH is 2 or less, it may be difficult to attain a desired effect by the content of the solvent, and when the pH is 7.5 or more, since the solution has alkalinity, a reaction speed may be very slow, and thus it may be difficult to manufacture the fluorine-based resin coating powder.

In the PH adjustment solution preparing step S30, the pH of the solution 120 may be adjusted to the set PH by using the acid.

The acid may be formed of an acidic solution not leaving a salt component in drying, such as a nitric acid and an acetic acid.

The fluorine silane may be formed of any one selected from perfluorooctyl triethoxysilane, triethyl(trifluoromethyl)silane, trimethyl(trifluoromethyl)silane, trimethoxy (3,3,3-trifluoropropyl)silane, trimethyl(trifluoromethyl)silane, dimethoxy-methyl (3,3,3-trifluoropropyl)silane, diisopropyl (3,3,4,4,5,5,6,6-nonafluorohexyl)silane, triethoxy[4-(trifluoromethyl)phenyl]silane, 1H,1H,2H,2H-perfluorooctyltriethoxysilane, and the like.

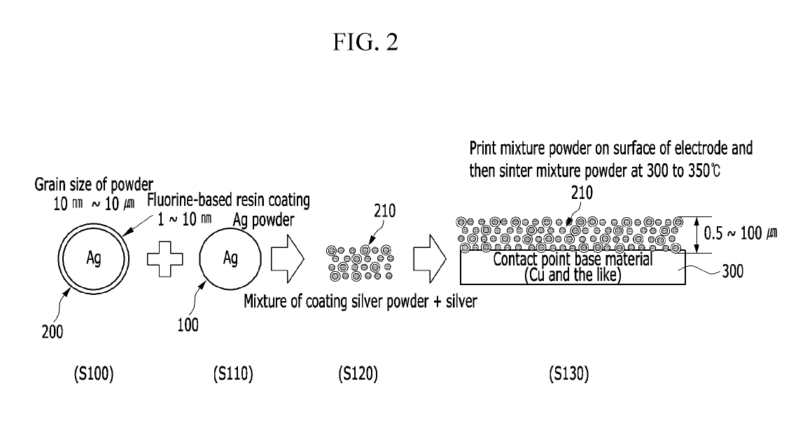

FIG. 2 is a schematic flowchart of the method for manufacturing the electrode material according to an exemplary embodiment of the present disclosure.

The description of the method for manufacturing the electrode material according to an exemplary embodiment of the present disclosure is the same as that of the method for manufacturing the fluorine-based resin coating powder according to an exemplary embodiment of the present disclosure with the exception of the following particular description, and thus the full detailed description thereof will be omitted.

Referring to FIG. 2, the method for manufacturing the electrode material according to an exemplary embodiment of the present disclosure may include a fluorine-based resin coating silver powder preparing step (S100) of preparing a fluorine-based resin coating silver powder 200 where a silver (Ag) powder 100 having a predetermined grain size is coated with a fluorine-based resin 140 at a set thickness, a silver powder preparing step (S110) of preparing the silver (Ag) powder 100 having the predetermined grain size, a silver powder mixing step (S120) of mixing the fluorine-based resin coating silver powder 200 prepared in the fluorine-based resin coating silver powder preparing step (S110) and the silver powder 100 prepared in the silver powder preparing step, and a sintering step (S130) of printing a mixture powder 210 mixed in the silver powder mixing step (S130) on a surface of an electrode (contact point base material) 300 and then sintering the mixture powder at a set sintering temperature.

In the silver powder preparing step (S110), the grain size of the silver powder 100 may be 10 nm to 10 μm, and a set coating thickness of the fluorine-based resin 140 may be 1 nm to 10 nm.

In a case where the grain size of the silver powder 100 is 10 nm or less, the surface may not be coated well due to an agglomeration phenomenon of the silver powder 100, which may not be suitable.

In addition, in a case where the grain size of the silver powder 100 is 10 μm or more, the size may be larger than about 1000 times of an actual coating thickness, and thus a friction reduction effect by coating may not be large, which may not be suitable.

Further, in the case where the grain size of the silver powder 100 is 10 μm or more, a temperature at which the contact point is sintered may be largely increased to 600° C. or more, so that there may be concern about damage to a coating film, which may not be suitable.

Therefore, it may be suitable that the grain size of the silver powder 100 is 20 nm to 10 μm, and it may be suitable that the coating thickness of the fluorine-based resin 140 is 1 nm to 10 nm.

In the sintering step (S130), the sintering temperature may be in the range of about 300 to 350° C.

In the sintering step (S130), a sintering time may be in the range of 1 to 30 minutes according to a printing amount.

In the sintering step (S130), a sintering thickness on the surface of the electrode may be 0.5 to 100 μm.

In the sintering step (S130), since the silver powder has the nano-size, sintering may be feasible at the printing temperature of about 300° C. which is lower than an actual melting point. At this temperature, since the fluorine-based resin 140 is not damaged, a desired result in the present disclosure may be obtained.

The electrode (contact point base material) 300 may be formed of copper (Cu) and the like.

Hereinafter, an action of the method for manufacturing the fluorine-based resin coating powder and the electrode material according to the exemplary embodiment of the present disclosure will be described with reference to FIGS. 1 and 2.

After the silver powder 100 is manufactured in a fine size, through fluorine-based resin coating treatment, a novel type fluorine-based resin coating silver powder 200 is manufactured.

That is, the silver (Ag) powder 100 having the grain size of 10 nm to 10 μm is prepared, the silver powder 100 is added to the ethanol solution 110, followed by mixing (S20), the solution 120 having the pH that is adjusted to 5.5 by using HNO₃ is prepared (S30), and fluorine silane 130 is prepared (S40).

In addition, the fluorine-based resin coating silver powder 200 coated with the fluorine-based resin 140 at a set thickness is manufactured by adding the silver powder 100 mixed with the ethanol solution 110 in the silver powder solution mixing step (S20) and the fluorine silane 130 prepared in the fluorine silane preparing step (S40) to the solution 120 having the pH that is adjusted to the PH set in the PH adjustment solution preparing step (S30), followed by mixing.

In this case, the coating thickness of the fluorine-based resin 140 may be set to 1 nm to 10 nm.

In addition, as described above, after the fluorine-based resin coating silver powder 200 coated with the fluorine-based resin 140 at the set thickness is manufactured, the silver powder 200, which is coated with the fluorine-based resin, and the silver powder 100, which is not coated with the fluorine-based resin, are appropriately mixed, and the mixture powder 210 is then printed on the surface of the electrode (contact point base material) 300 (S130).

In addition, after printing, the mixture powder 210 printed on the surface of the electrode (contact point base material) 300 may be sintered at about 300 to 350° C. for 1 to 30 minutes according to a printing amount.

Since the silver powder 100 has a nano-size, sintering is feasible at the printing temperature of about 300° C. which is lower than an actual melting point. At this temperature, since the fluorine-based resin is not damaged, a desired result in the present disclosure may be obtained.

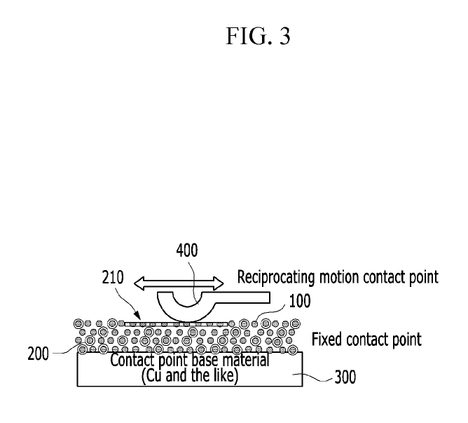

FIG. 3 is a view illustrating a use state of the electrode material manufactured according to a method for manufacturing the fluorine-based resin coating powder and an electrode material according to an exemplary embodiment of the present disclosure.

Referring to FIG. 3, abrasion may occur on the surface of the contact point base material 300 as the switch 400 is operated, and in this case, the fluorine silane 130 of the surface of the fluorine-based resin coating silver powder 200 trespasses on the sintered pore to attain the continuous lubrication effect, and this phenomenon may reduce the friction coefficient of the contact point and improve abrasion resistance characteristics.

[Table 1] is a table exhibiting comparison evaluation results of the existing technology (silver plating) and the Example of the present disclosure (fluorine-based resin coating silver powder) with respect to the abrasion resistance lifespan (number) according to the kind of the contact point.

According to the following [Table 1], it can be seen that in the case of the Example of the present disclosure (fluorine-based resin coating silver powder), as compared to the case of the existing technology (silver plating), the abrasion resistance lifespan (number) is significantly increased.

TABLE 1

| | | | | Example of the Present | |
|---|---|---|---|---|---|
| | Existing Technology | | | Disclosure (fluorine-based | |
| | (silver plating) | | | resin coating silver powder | |
| Classification | 1 μm | 5 μm | 20 μm | 5 μm | 10 μm |
| 1 | 55,670 | 301,054 | 1,910,154 | 2,510,245 | 6,541,215 |
| 2 | 60,247 | 312,574 | 2,117,557 | 2,915,515 | 6,687,144 |
| 3 | 54,328 | 354,245 | 2,520,136 | 2,717,389 | 6,781,102 |
| 4 | 57,234 | 294,387 | 2,312,228 | 2,880,108 | 6,241,047 |
| 5 | 59,214 | 332,157 | 2,215,412 | 2,651,138 | 5,987,513 |

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A method for manufacturing a fluorine-based resin coating powder, the method comprising:
a silver powder preparing step of preparing a silver powder having a predetermined grain size;
a silver powder solution mixing step of adding the silver powder to an ethanol solution, followed by mixing;
a PH adjustment solution preparing step of preparing a solution having a pH that is adjusted to a set PH;
a fluorine silane preparing step of preparing fluorine silane; and
a fluorine-based resin coating silver powder manufacturing step of manufacturing a fluorine-based resin coating silver powder coated with the fluorine-based resin at a set thickness by adding the silver powder mixed with the ethanol solution in the silver powder solution mixing step and the fluorine silane prepared in the fluorine silane preparing step to the solution having the pH that is adjusted to the PH set in the PH adjustment solution preparing step, followed by mixing.

2. The method of claim 1, wherein in the silver powder preparing step, the grain size of the silver powder is 10 nm to 10 μm.

3. The method of claim 2, wherein a coating thickness of the fluorine-based resin is 1 nm to 10 nm.

4. The method of claim 1, wherein in the PH adjustment solution preparing step, the pH of the solution is set to a range of 2 to 7.5.

5. The method of claim 4, wherein in the PH adjustment solution preparing step, the pH of the solution is adjusted to the set pH by using an acid.

6. The method of claim 5, wherein the acid is formed of a nitric acid and an acetic acid not leaving a salt component in drying.

7. The method of claim 4, wherein the fluorine silane is formed of any one selected from perfluorooctyl triethoxysilane, triethyl(trifluoromethyl)silane, trimethyl(trifluoromethyl)silane, trimethoxy (3,3,3-trifluoropropyl)silane, trimethyl(trifluoromethyl)silane, dimethoxy-methyl (3,3,3-trifluoropropyl)silane, diisopropyl (3,3,4,4,5,5,6,6-nonafluorohexyl)silane, triethoxy[4-(trifluoromethyl)phenyl]silane, and 1H,1H,2H,2H-perfluorooctyltriethoxysilane.

8. A method for manufacturing an electrode material, the method comprising:
a fluorine-based resin coating silver powder preparing step of preparing a fluorine-based resin coating silver powder where a silver powder having a predetermined grain size is coated with a fluorine-based resin at a set thickness;
a silver powder preparing step of preparing the silver powder having the predetermined grain size;
a silver powder mixing step of mixing the fluorine-based resin coating silver powder prepared in the fluorine-based resin coating silver powder preparing step and the silver powder prepared in the silver powder preparing step; and
a sintering step of printing a mixture powder mixed in the silver powder mixing step on a surface of an electrode and then sintering the mixture powder at a set sintering temperature.

9. The method of claim 8, wherein in the silver powder preparing step, the grain size is 10 nm to 10 μm.

10. The method of claim 9, wherein a coating thickness of the fluorine-based resin is 1 nm to 10 nm.

11. The method of claim 8, wherein in the sintering step, the sintering temperature is set to a range of 300 to 350° C.

12. The method of claim 11, wherein in the sintering step, a sintering time is set to a range of 1 to 30 minutes according to a printing amount.
